(19) United States
(12) Patent Application Publication
(10) Pub. No.: US 2008/0195828 A1
(43) Pub. Date: Aug. 14, 2008

(54) Methods of writing data in a non-volatile memory device to place data in an in-place arrangement

(75) Inventors: Jin-hyuk Kim, Gyeonggi-do (KR); Jae-wook Cheong, Seoul (KR); Young-gon Kim, Gyeonggi-do (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 12/069,765

(22) Filed: Feb. 13, 2008

(30) Foreign Application Priority Data
Feb. 13, 2007 (KR) 10-2007-0015090

(51) Int. Cl. G06F 12/16

(52) U.S. Cl. 711/162; 711/E12.103

(57) ABSTRACT

Provided is a data writing method of copying data having logical pages prior to logical pages of data to write from a data block used in non-volatile memory device. The data writing method includes copying data having logical pages prior to a logical page of data to write from a second block to a first block, and writing the data to write in a page next to the copied prior logical pages.

### CROSS-REFERENCE TO RELATED PATENT APPLICATION

This application claims the benefit of Korean Patent Application No. 10-2007-0015090, filed on Feb. 13, 2007, in the Korean Intellectual Property Office, the disclosure of which is incorporated herein by reference as if set forth in its entirety.

### BACKGROUND OF THE INVENTION

1. Field of the Invention

The present invention relates to data writing methods used in a non-volatile memory device, and, more particularly, to data writing methods of copying data associated with logical pages prior to logical pages of data to write from a data block used in a non-volatile memory device.

2. Description of the Related Art

A non-volatile memory device, which is electrically erasable or programmable, can retain stored data even when not powered. A flash memory is a representative non-volatile memory.

### SUMMARY

Some embodiments of the present invention provide a data writing method of copying data having logical pages prior to logical pages of data to write from a data block used in a non-volatile memory device.

In some embodiments of the present invention, a data writing method used in a non-volatile semiconductor memory device includes copying data associated with logical pages prior to a logical page of data to write from a second block to a first block, and writing the data to write in a page next to the copied prior logical pages.

In other embodiments, the data to write is written in a physical page of the first block, which corresponds to a logical page of the data to write.

In still other embodiments, data of the prior logical pages is copied to physical pages of the first block that correspond to the prior logical pages.

In still other embodiments, pages of the second block corresponding to a difference between a beginning of a first physical page of empty physical pages in the first block and the logical page of the data to write are copied to the first block.

In still other embodiments, data are copied beginning at the first physical page of empty physical pages of the first block through the prior physical pages.

In still other embodiments, data are copied to a physical page next to a physical page of the first block in which the data to write is written.

In still other embodiments, when the logical page of the data to write is equal to the next physical page, copying data to the first block is not performed.

In still other embodiments, the non-volatile semiconductor memory device does not retain page offset information, which represents a difference between a logical page of the data to write and a physical page in which the data to write is written.

In still other embodiments, the method further includes determining whether physical pages of the first block in which data have been written in advance are arranged in an in-place arrangement.

In still other embodiments, the method further includes determining whether physical pages of the first block to which the data associated with prior logical pages is to be copied are empty.

In still other embodiments, the method further includes allocating the first block in which the data to write is to be written.

In still other embodiments, the first block is a log block in which data is currently written and the second block is a data block in which data was written in advance.

### BRIEF DESCRIPTION OF THE DRAWINGS

The above and other features and advantages of the present invention will become more apparent by describing in detail exemplary embodiments thereof with reference to the attached drawings in which:

FIGS. 1A and 1B are block diagrams that illustrate operations of arranging data in a data block;

FIGS. 2A and 2B are block diagrams that illustrate operations of merging data in a block;

FIG. 3 is a block diagram for explaining a data writing method of copying data associated with logical pages prior to logical pages of data to write from a data block according to some embodiments of the present invention;

FIG. 4 is a flowchart illustrating a data writing method according to some embodiments of the present invention;

FIG. 5 is a block diagram that illustrates a wrap-around type data writing method according to a comparative which is compared to the data writing method according to some embodiments of the present invention; and

FIG. 6 is a block diagram that illustrates comparison between a data writing method according to some embodiments of the present invention and a data writing method according to the comparative example of FIG. 5.

### DETAILED DESCRIPTION OF EMBODIMENTS OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The flash memory includes a number of blocks for storing data in units of a page. As a method of arranging pages of the data in the block, there is in-place arrangement and out-of-place arrangement.

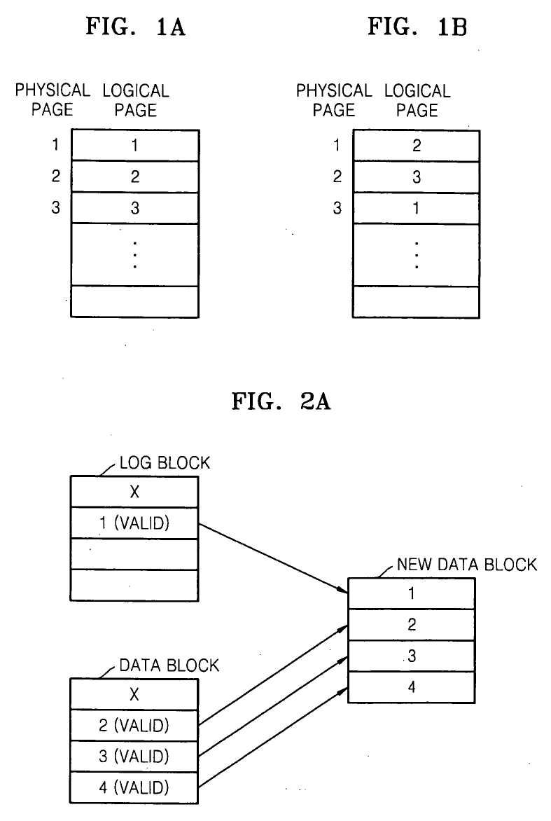

FIG. 1A is a block diagram that illustrates the in-place arrangement, and FIG. 1B is a view for explaining the out-of-place arrangement. Referring to FIG. 1A, in the in-place arrangement, logical pages and physical pages of data are arranged to correspond to each other. Referring to FIG. 1B, in the out-of-place arrangement, logical pages and physical pages do not correspond to each other.

As a method of merging data in the block, there is a simple-merge operation and a copy-merge operation.

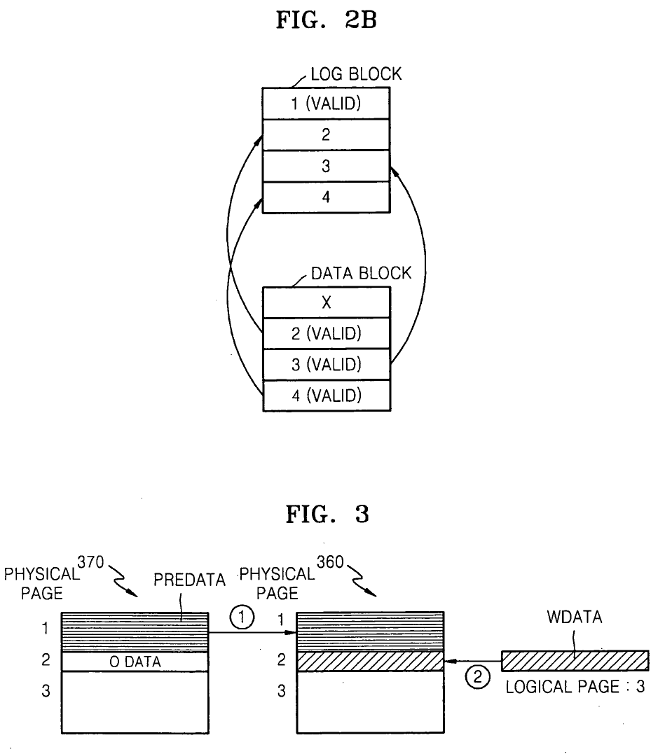

FIG. 2A is a block diagram that illustrates the simple-merge operation. Referring to FIG. 2A, the simple-merge operation is an operation of merging pages included in a plurality of source blocks (log blocks and data blocks) into a new target block (new data block). In the simple merge operation, data can be merged regardless of data arrangement. Namely, data can be merged regardless of whether the data is arranged in the in-place arrangement or the out-of-place arrangement. For example, in FIG. 2A, data of a first logical page is written in a second physical page of the source block (log block). Therefore, in the simple merge operation, merging can be performed on the source block (log block) having the out-of-place arrangement.

FIG. 2B is a block diagram for explaining the copy-merge operation. Referring to FIG. 2B, the copy merge operation is an operation of directly merging data of the source block (data block) into a target block (log block).

In the simple-merge operation, reading and writing operations have to be performed on the entire block, so that a large amount of writing/reading operations are typically required as compared with the copy-merge operation. Therefore, as the simple merge operation is performed more frequently, merging performance may be degraded and writing performance may also be degraded.

However, to perform the copy-merge operation, data in the target block has to be effective data and has to be arranged in the in-place arrangement. For example, in FIG. 2A, data of a first logical page is written in the first physical page of the target block (log block). In this case, the copy-merge operation cannot be performed.

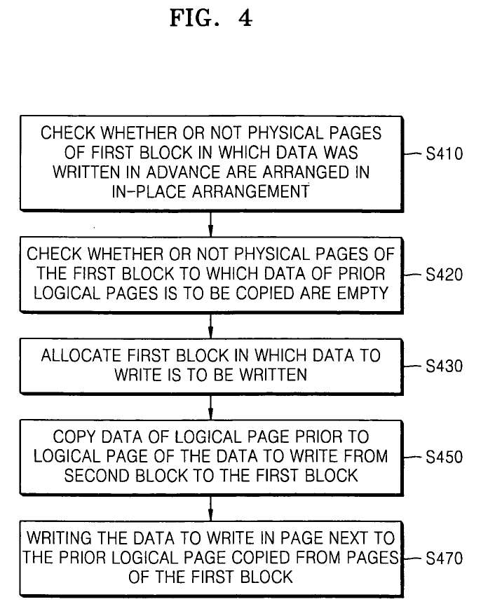

FIG. 3 is a block diagram that illustrates a data writing method of copying data of logical pages prior to logical pages of data to write from a data block according to some embodiments of the present invention.

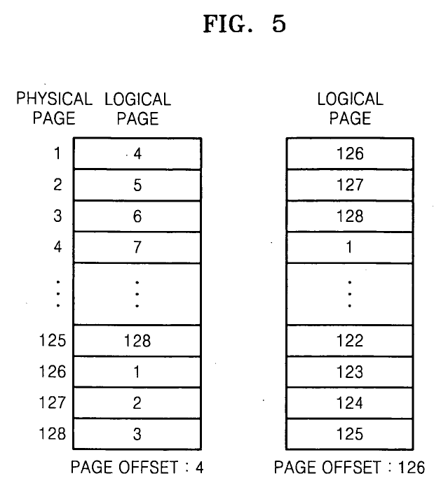

FIG. 4 is a flowchart illustrating a data writing method according to some embodiments of the present invention.

Referring to FIGS. 3 and 4, a data writing method according to some embodiments of the present invention includes copying data PREDATA associated with logical pages prior to one or more logical pages of data to write WDATA from a second block 370 to a first block 360 (operation S450), and writing the data to write WDATA in a page next to the copied prior one or more logical pages (operation S470).

According to some embodiments of the present invention, the data to write WDATA is not written in a first page of the first block 360 but is written in a physical page corresponding to a logical page of the data to write WDATA. The data PREDATA copied from the second block 370 is written from a first page of the first block 360 up to a physical page in which the data to write WDATA is written. For example, when the data to write WDATA in FIG. 3 is associated with a logical page 3, data PREDATA associated with logical pages 1 and 2 is copied from the second block 370 and is written in physical pages 1 and 2 of the first block 360. Thereafter, the data to write WDATA associated with the logical page 3 is written in the physical page 3.

Accordingly, the data writing method according to some embodiments of the present invention may have an advantage in that data in a block can be arranged in the in-place arrangement in which logical pages and physical pages of data in the block correspond to each other.

In addition, in the data writing method according to some embodiments of the present invention, logical pages and physical pages of data WDATA and PREDATA correspond to each other. Therefore, there may be an advantage in that page offset information, which indicates a difference between a logical page of data and a physical page in which data is written, need not be maintained.

The first block 360 may be a log block in which data is currently written, and the second block 370 may be a data block in which data was written in advance.

In writing the data to write (operation S470), the data WDATA may be written in a physical page (for example, a physical page 3) of the first block 360, which corresponds to a logical page (for example, a logical page 3) of the data to write WDATA.

In copying data to the first block (operation S450), data PREDATA associated with one or more prior logical pages may be copied to physical pages (for example, physical pages 1 and 2) of the first block 360, which correspond to the prior logical pages (for example, logical pages 1 and 2).

In copying data to the first block (operation S450), pages (for example, the logical pages 1 and 2) of the second block 370 corresponding to a difference between a beginning of the first physical page (for example, a physical page 1) of empty physical pages in the first block 360 and a logical page (for example, the logical page 3) of the data to write WDATA may be copied to the first block 360.

In copying data to the first block (operation S450), data PREDATA may be copied beginning at the first physical page (for example, the physical page 1) of the empty physical pages in the first block 360 through the prior physical pages of the first block 360 that correspond to the prior logical pages of the second block 370.

In copying data to the first block (operation S450), data associated with logical pages (for example, the logical page 2) prior to the logical page of the data to write WDATA may be copied to the first block 360.

In copying data to the first block (operation S450), the data PREDATA of the prior logical one or more pages may be copied to a physical page (for example, the physical page 3) next to a physical page (for example, a physical page 2) of the first block 360 in which data WDATA is written.

In the data writing method according to the above-described embodiments, when the logical page of the data to write WDATA and the physical page in which the data to write WDATA will be written are equal to each other, copying data to the first block (operation S450) may not be performed. For example, when the data to write WDATA has the logical page 1 and all physical pages of the first block 360 are empty, the data to write WDATA may be stored in the physical page 1 of the first block 360 without copying data to the first block from the second block.

The data writing method according to some embodiments of the present invention may further include checking whether or not physical pages of the first block in which data was written in advance are arranged in the in-place arrangement (operation S410). For example, when the data to write WDATA is associated with logical page 3, a determination is made whether physical pages 1 and 2 of the first block 360 are empty. In addition, the data PREDATA copied from the second block 370 may be written in the empty physical pages 1 and 2. The data writing method according to some embodiments of the present invention may further include checking whether or not physical pages of the first block in which data of prior logical pages is to be written are empty. For example, when the data to write WDATA is associated with logical page 3, a determination is made whether the physical page 3 of the first block 360 is empty. Further embodiments of the present invention may include allocating the first block 360 in which the data to write WDATA is to be written.

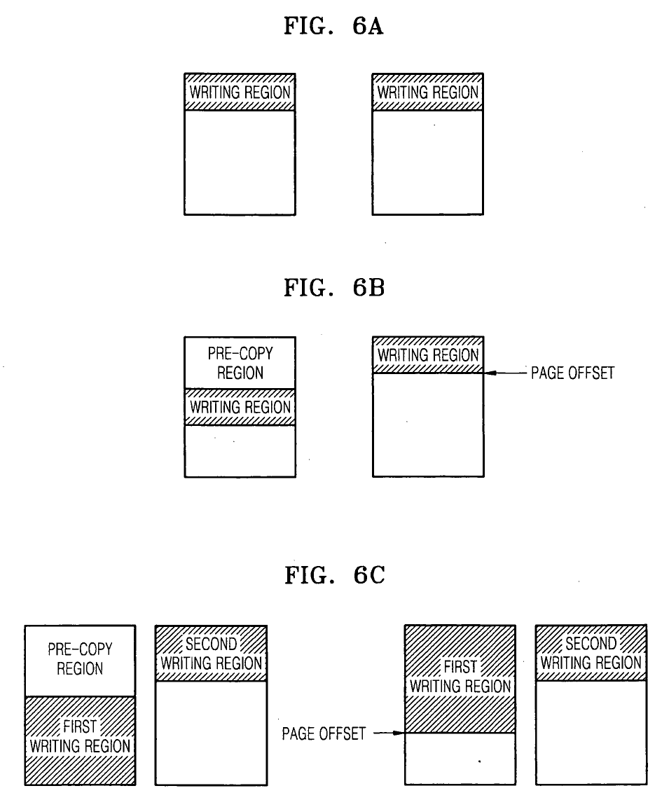

FIG. 5 is a block diagram that illustrates a wrap-around type data writing method according to a comparative example, which is compared to the data writing method according to some embodiments of the present invention.

As shown in FIG. 5, the out-of-place arrangement is allowed and the page-offset information is additionally retained. Referring to the left block of FIG. 5, data having a logical page 4 is written in a physical page 1. Thereafter, a page offset of 4 that represents the logical page 4 written in the physical page 1 is additionally retained. In addition, referring to the right block of FIG. 5, data in a logical page 126 is written in a physical page 1. Thereafter, a page offset of 126 that represents the logical page 126 written in the physical page 1 is additionally retained.

In the wrap-around type data writing method according to a comparative example, the page-offset information has to be additionally retained, which means that resources for the information are needed. On the other hand, the data writing method according to some embodiments of the present invention may have an advantage in that the page offset information, which represents a difference between a logical page of data and a physical page in which data is written, needs not be retained.

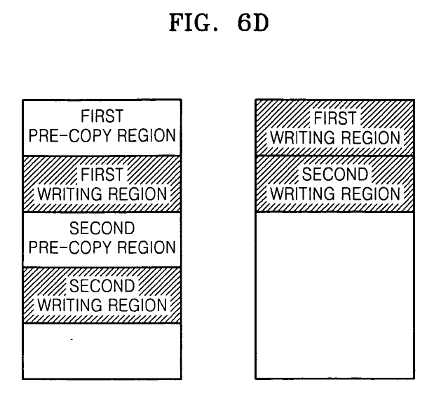

FIG. 6 is a block diagram that illustrates a comparison between the data writing method according to some embodiments of the present invention and the data writing method according to the comparative example of FIG. 5. Left blocks illustrated in FIGS. 6A to 6D are blocks for illustrating the data writing method according to some embodiments of the present invention, and the right blocks illustrated in FIGS. 6A to 6D are blocks for illustrating the data writing method according to the comparative example of FIG. 5.

FIG. 6A illustrates a case where data to write is associated with a logical page 1. In this case, in the data writing method according to some embodiments of the present invention and the data writing method according to the comparative example of FIG. 5, the data to write are written from the front of the block.

FIG. 6B illustrates a case where data to write is not associated with a logical page 1. In this case, in the data writing method according to the comparative example of FIG. 5, data to write is written from the front of the block, and page offset information is retained. On the other hand, in the data writing method according to some embodiments of the present invention, the data to write is written in a physical page corresponding to a logical page of the data to write.

FIG. 6C illustrates a case where data to write is written in two blocks. In this case, in the data writing method according to the comparative example of FIG. 5, the page-offset information has to be retained. On the other hand, in the data writing method according to some embodiments of the present invention, the page offset information need not be retained.

FIG. 6D illustrates a case where two sets of data to write associated with two separate logical pages are written. In this case, two pieces of page-offset information have to be retained so that the data writing method according to the comparative example of FIG. 5 cannot be applied. On the other hand, in the data writing method according to some embodiments of the present invention, data having prior logical pages is copied and thereafter data to write is written. Therefore, the data to write can be written in a physical page corresponding to a logical page of the data to write.

As described above, in the data writing method used in a non-volatile memory device according to some embodiments of the present invention, data having logical pages prior to a logical page of the data to write is copied into another block that is not a block in which data to write is to be written. Accordingly, data in the block can be arranged in the in-place arrangement in which a logical page of data in the block and a physical page correspond to each other. Therefore, the copy-merge operation can be performed instead of the simple-merge operation on the block, and the merging performance can be improved.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

That which is claimed:

1. A data writing method used in a non-volatile semiconductor memory device, comprising:
copying data associated with logical pages prior to a logical page of data to write from a second block to a first block; and
writing the data to write in a page next to the copied prior logical pages.

2. The method of claim 1, wherein in writing the data to write, the data to write is written in a physical page of the first block which corresponds to a logical page of the data to write.

3. The method of claim 1, wherein in copying data to the first block, data of the prior logical pages is copied to physical pages of the first block that correspond to the prior logical pages.

4. The method of claim 1, wherein in copying data to the first block, pages of the second block corresponding to a difference between a beginning of a first physical page of empty physical pages in the first block and the logical page of the data to write are copied to the first block.

5. The method of claim 1, wherein in copying data to the first block, data are copied beginning at the first physical page of empty physical pages of the first block through the prior physical pages.

6. The method of claim 1, wherein in copying data to the first block, data are copied to a physical page next to a physical page of the first block in which the data to write is written.

7. The method of claim 6, wherein when the logical page of the data to write is equal to the next physical page, copying data to the first block is not performed.

8. The method of claim 1, wherein the non-volatile semiconductor memory device does not retain page offset information, which represents a difference between a logical page of the data to write and a physical page in which the data to write is written.

9. The method of claim 1, further comprising determining whether physical pages of the first block in which data have been written in advance are arranged in an in-place arrangement.

10. The method of claim 1, further comprising determining whether physical pages of the first block to which the data associated with prior logical pages is to be copied are empty.

11. The method of claim 1, further comprising allocating the first block in which the data to write is to be written.

12. The method of claim 1,
wherein the first block is a log block in which data is currently written; and
wherein the second block is a data block in which data was written in advance.

13. A method of writing data to write in a first block used in a non-volatile semiconductor memory device, the method comprising:
copying data corresponding to a difference between a logical page of the data to write and a beginning of the logical page sequence from a second block to a first empty physical page of the first block; and
writing the data to write in a next page of the copied data.

14. The method of claim 13, wherein in writing the data to write, the data to write is written in a physical page of the first block which is equal to the logical page of the data to write.

15. The method of claim 13, wherein copying data to the first block is not performed when the logical page of the data to write is equal to the first empty physical page of the first block.

16. The method of claim 13, wherein the non-volatile semiconductor memory device does not retain page offset information, which represents a difference between the logical page of the data to write and a physical page in which the data to write is written.
